(19) United States
(12) Patent Application Publication
(10) Pub. No.: US 2003/0025365 A1
(43) Pub. Date: Feb. 6, 2003

(54) Seat structure for vehicle

(75) Inventors: Yuji Sato, Tokyo (JP); Toshiaki Orihara, Tokyo (JP); Joutaro Shiino, Tokyo (JP); Takahiro Nakamura, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: HINO MOTORS, LTD., Hino-shi (JP)

(21) Appl. No.: 10/147,887

(22) Filed: May 20, 2002

(30) Foreign Application Priority Data
Aug. 1, 2001 (JP) 2001-233954

(51) Int. Cl. B60N 2/427

(52) U.S. Cl. 297/216.1

(57) ABSTRACT

A seat structure for a vehicle has a deformation suppressant on at least one of a beam and an other region against deformation of the beam when a downward load acts on a front portion of the seat cushion upon for example vehicular collision or abrupt braking so that rigidity of the seat cushion can be enhanced with no reinforcement such as increase in diameter and/or thickness of the beam and/or a seat cushion frame, making the beam and/or the frame double-walled and/or use of high-strength material for the beam and/or the frame.

### BACKGROUND OF THE INVENTION

1. Field of the Invention

The present invention relates to a seat structure for a vehicle.

2. Description of the Related Art

Generally, as shown in FIG. 1, a seat for a vehicle comprises a seat cushion 1 for support of buttocks of an occupant and a seat back 2 for support of a back of the occupant. The seat cushion 1 accommodates a seat cushion frame 3 as a skeleton or reinforcement member of the seat. In order to prevent a so-called submarine phenomenon that an occupant bound by a seat belt may slip out forward from below the seat belt upon generation of shock due to for example vehicular collision or abrupt braking, a beam or submarine pipe 4 is conventionally arranged in a front portion of the seat cushion 1 to extend transversely of the vehicle. The beam or submarine pipe 4 presses backsides of the occupant's thighs against forward slippage of his or her buttocks so as to prevent sinkage or subduction of the occupant upon generation of shock.

However, when a child seat 5 is set on the vehicular seat as shown in FIG. 2A through engagement of a connector 7 to a lower anchor 6 in a bottom of the seat back 2, the child seat 5 may be swung downward as shown in FIG. 2B around the lower anchor 6 by a forward excessive load F acting on the child seat 5 upon for example vehicular collision or abrupt braking; as a result, a downward load acts on the front portion of the seat cushion 1 to deform the submarine pipe 4, resulting in increased displacement of the child seat 5. In FIGS. 2A and 2B, reference numeral 8 denotes a floor on which the seat cushion 1 is installed.

Conventionally, this is overcome by reinforcement such as increase in diameter and/or thickness of the beam or submarine pipe 4 and/or the seat cushion frame 3, making the beam and/or the frame double-walled and/or use of high-strength material for the beam and/or the frame, which will inevitably cause increase in weight and cost.

In view of the above, the invention has its object to provide a seat structure for a vehicle which can enhance rigidity of the seat cushion and suppress increase in weight and cost with no reinforcement such as increase in diameter and/or thickness of a beam and/or a seat cushion frame, making the beam and/or the frame double-walled and/or use of high-strength material for the beam and/or the frame and which can suppress displacement of a child seat set on the seat cushion upon generation of shock to thereby attain stabilization of the seat with the child seat being set.

### SUMMARY OF THE INVENTION

The invention relates to a seat structure for a vehicle comprising a seat cushion, a seat cushion frame accommodated in the seat cushion, a beam in a front portion of the seat cushion and extending transversely of the vehicle and deformation suppressive means on at least one of the beam and an other region for suppressing deformation of the beam through contact with the other region when a downward load acts on the front portion of the seat cushion.

This brings about the following effects and advantages:

The deformation of the beam by the downward load acting on the beam upon for example vehicular collision or abrupt braking is suppressed by the deformation suppressive means on at least one of the beam and the other region so that rigidity of the seat cushion can be enhanced with no reinforcement such as increase in diameter and/or thickness of the beam and/or of the seat cushion frame, making the beam and/or the frame double-walled and/or use of high-strength material for the beam and/or the frame. When a child seat is set on the seat cushion, displacement of the child seat upon generation of shock can be suppressed.

The deformation suppressive means may be provided by a downward bent on the beam. Such mere change in shape of the beam can suppress deformation of the beam with no additional parts for reinforcement at all and suppress increase in weight and cost. Ordinal installability of the seat to the vehicle is not barred since no change is made on a floor of the vehicle.

The deformation suppressive means may be provided by leg members attached to a lower portion of the beam. Unlike the above-mentioned bent which has restriction in position relationship with an occupant for prevention of the submarine phenomenon as well as restriction in shape itself in workability, the leg members have greater degree of freedom in positioning and shape itself. Ordinal installability of the seat to the vehicle is not barred since no change is made on the floor of the vehicle.

The floor on which the seat cushion is installed may be employed as the above-mentioned other region, and the deformation suppressive means may be provided by a projection on the floor. In this case, the deformation suppressive means may be also formed on the beam; then, these deformation suppressive means on the floor and on the beam may be mutually decreased in degree of projection, advantageously resulting in good workability and assurance of rigidity.

Embodiments of the invention will be described in conjunction with the drawings.

### BRIEF DESCRIPTION OF THE DRAWINGS

FIG. 1 is a partly see-though perspective view of a conventional seat for a vehicle;

FIGS. 2A and 2B are partly cutaway side views of the conventional seat with a child seat being set, showing states before and after a load being applied, respectively;

FIGS. 3A and 3B are partly cutaway side views of an embodiment of the invention, showing states before and after a load being applied, respectively;

FIG. 4 is a perspective view showing a beam or submarine pipe and a seat cushion frame in the embodiment shown in FIGS. 3A and 3B;

FIG. 5 is a plan view showing possible positions of a bent in the embodiment shown in FIGS. 3A, 3B and 4;

FIG. 6 is an enlarged side view showing important portions in a further embodiment of the invention;

FIG. 7 is a perspective view showing a beam or submarine pipe with leg members and a seat cushion frame in the further embodiment shown in FIG. 6;

FIG. 8 is a perspective view showing a modification of the leg members shown in FIG. 7;

FIG. 9 is an enlarged side view showing important portions in a still further embodiment of the invention with a bent on the beam or submarine pipe as well as a corresponding bent on the seat cushion frame as the other region;

FIG. 10 is a perspective view of the beam or submarine pipe and the seat cushion frame as the other region shown in FIG. 9;

FIG. 11 is an enlarged side view showing important portions in a modification of the still further embodiment shown in FIGS. 9 and 10 with a pan type seat cushion frame as the other region;

FIG. 12 is a perspective view showing the pan type seat cushion frame shown in FIG. 11;

FIGS. 13A and 13B are partly cutaway side views of a still further embodiment of the invention with an upper plate, as the other region, of a storage or of a cup holder arranged under the seat cushion, showing states before and after a load being applied, respectively;

FIG. 14 is an enlarged side view showing important portions in a still further embodiment of the invention with a bracket or projection on a floor on which the seat cushion is installed to provide deformation suppressive means against deformation of the beam or submarine pipe;

FIG. 15 is an enlarged side view showing important portions in a modification of the still further embodiment shown in FIG. 14 with the submarine pipe being also formed with a bent as deformation suppressive means for the pipe;

FIG. 16 is an enlarged side view showing important portions in a still further embodiment of the invention with a floor as the other region on which the seat cushion is installed, the deformation suppressive means being provided by a bead or protrusion on the floor;

FIG. 17 is an enlarged side view showing important portions in a still further embodiment of the invention with guides on a floor on which the seat cushion is installed so as to guide a downward movement of a bent on the beam or submarine pipe;

FIG. 18 is an enlarged side view showing important portions in a modification of the still further embodiment shown in FIG. 17 with guides on an upper plate of a storage or of a cup holder arranged under the seat cushion so as to guide a downward movement of a bent on the beam or submarine pipe; and

FIG. 19 is an enlarged side view showing important portions in a still further embodiment of the invention with a beam or submarine pipe having a flat-bottomed bent.

### DETAILED DESCRIPTION OF THE PREFERRED EMBODIMENTS

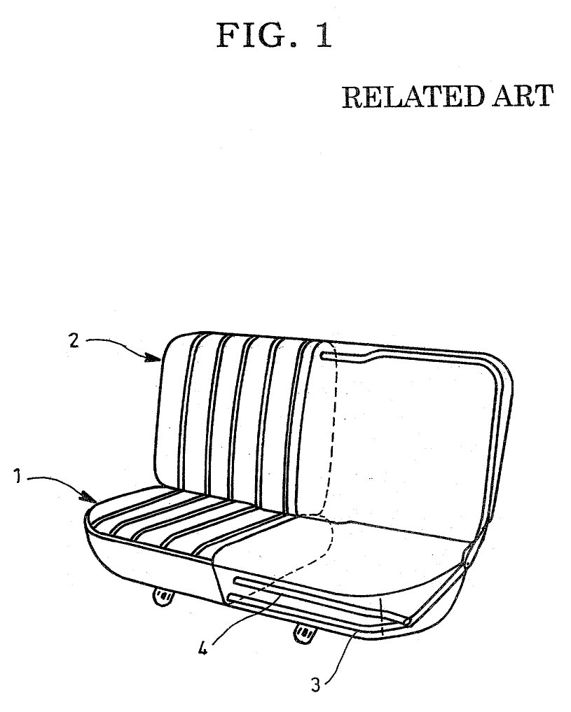

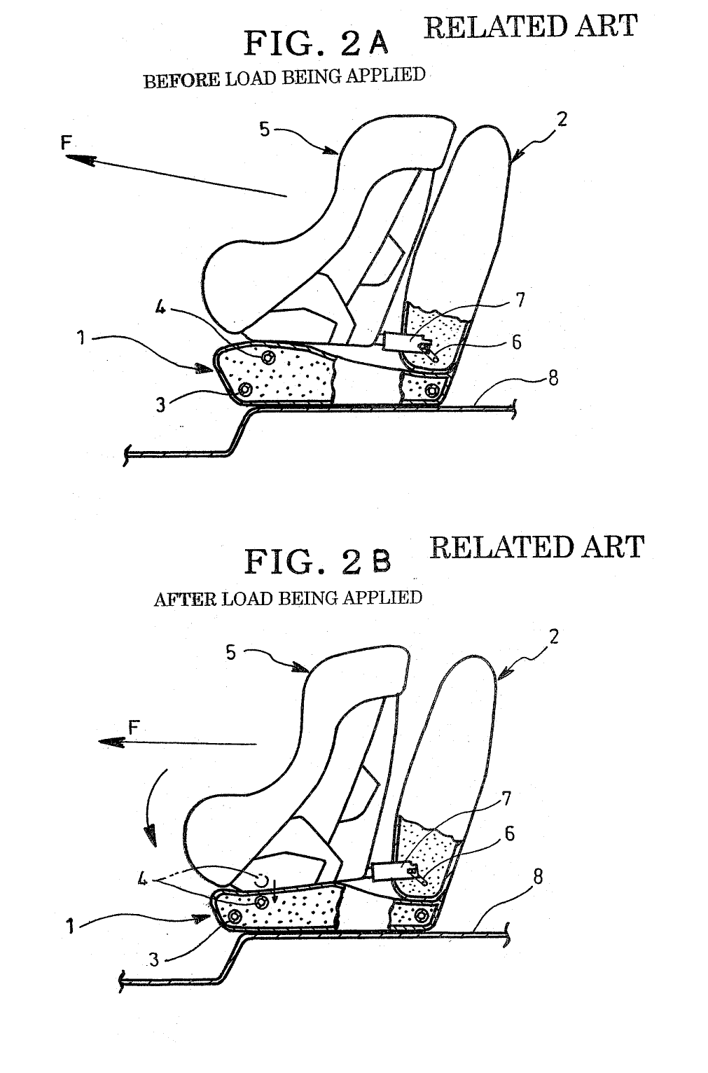

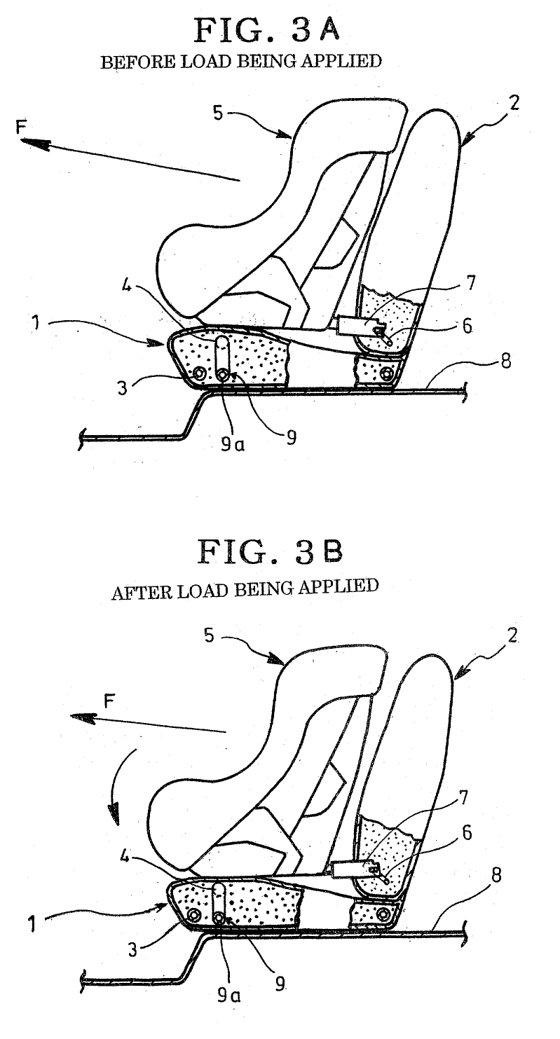

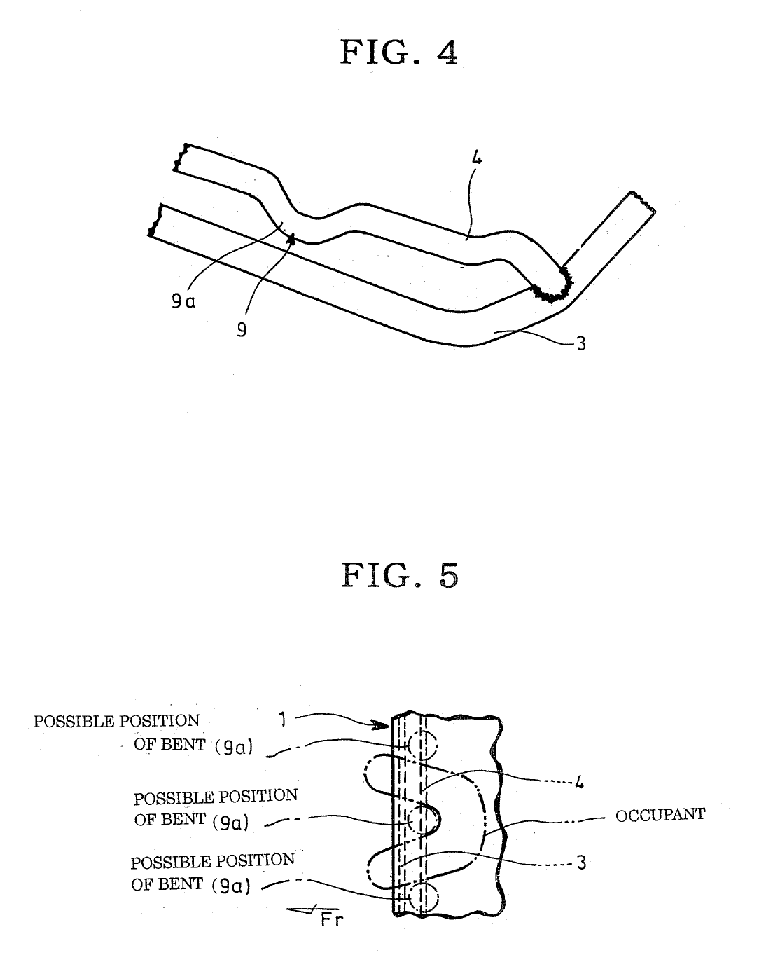

FIGS. 3A, 3B and 4 show an embodiment of the invention in which the same parts as those in FIGS. 1, 2A and 2B are represented by the same reference numerals and which has the same fundamental structure as that of the related art shown in FIGS. 1, 2A and 2B. The embodiment is characteristic in that, as shown in FIGS. 3A, 3B and 4, it has deformation suppressive means 9 on a beam or submarine pipe 4 to suppress deformation of a beam or submarine pipe 4 through contact with a floor 8 as an other region when a downward load acts on a front portion of a seat cushion 1.

In the embodiment, the deformation suppressive means 9 is provided by a downward bent 9a on the submarine pipe 4.

As shown in FIG. 5, preferably the bent 9a as the deformation suppressive means 9 is arranged in a position relationship with an occupant or occupants, such as between knees of the occupant or between the occupants, so as not to adversely affect the submarine-phenomenon preventive performance.

Next, a mode of operation of the embodiment will be described.

Upon for example vehicular collision or abrupt braking, a downward load acts on the front portion of the seat cushion 1 so as to deform the beam or submarine pipe 4; however, the bent 9a on the submarine pipe 4 as the deformation suppressive means 9 contacts at its bottom with the floor 8 to suppress the deformation of the submarine pipe 4 so that rigidity of the seat cushion 1 can be enhanced with no reinforcement such as increase in thickness and/or diameter of the beam or submarine pipe 4 and/or the seat cushion frame 3, making the beam and/or the frame double-walled and/or use of high-strength material for the beam and/or the frame. As a result, when a child seat 5 is set on the seat cushion 1 as shown in FIG. 3A, displacement of the child seat 5 can be suppressed upon generation of shock as shown in FIG. 3B.

In the embodiment, the deformation suppressive means 9 is provided by the downward bent 9a on the submarine pipe 4. That is, merely changing the shape of the submarine pipe 4 can suppress the deformation of the submarine pipe 4 with no parts being added for reinforcement, and can suppress increase in weight and cost. Ordinal installability of the seat to the vehicle is not barred since no change is made on the floor 8.

Thus, rigidity of the seat cushion 1 can be enhanced with no reinforcement such as increase in diameter and/or thickness of the beam or submarine pipe and/or the seat cushion frame 3, making the beam and/or the frame double-walled and/or use of high-strength material for the beam and/or the frame so that increase in weight and cost can be suppressed. When the child seat 5 is set on the seat cushion 1, displacement of the child seat 5 can be suppressed upon generation of shock, resulting in stabilization of the seat with the child seat 5 being set.

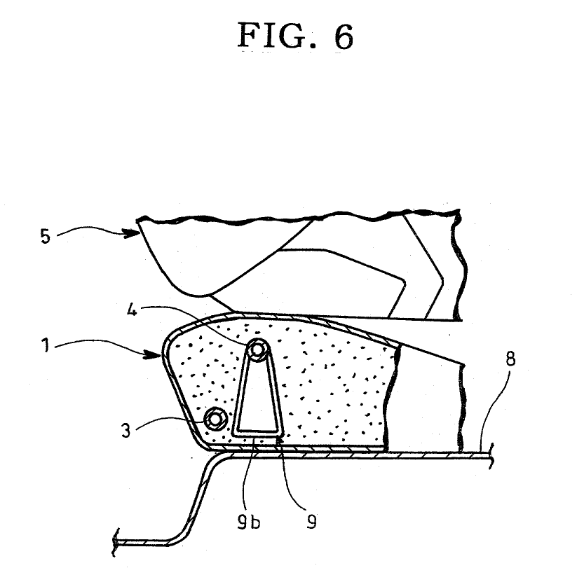

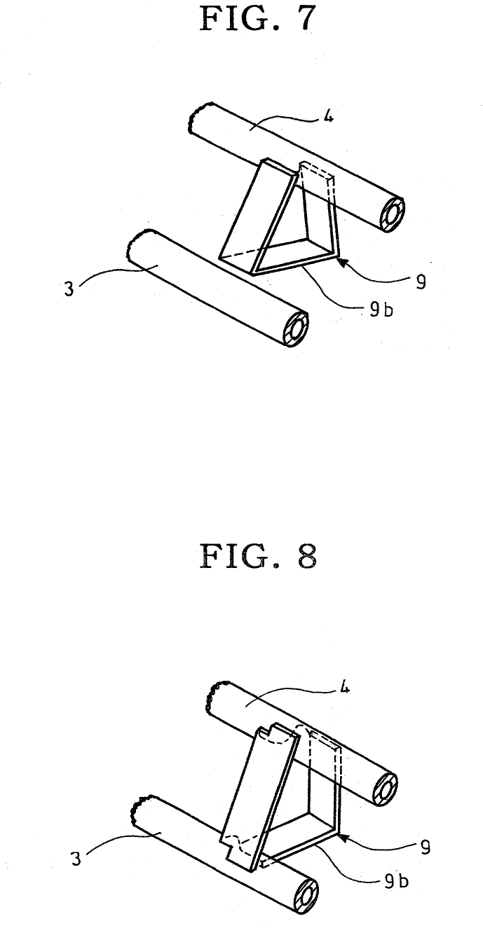

FIGS. 6 and 7 show a further embodiment of the invention in which the same parts as those shown in FIGS. 1, 2A and 2B are represented by the same reference numerals and in which deformation suppressive means 9 is provided by scaffold-shaped leg members 9b attached to a lower portion of a beam or submarine pipe 4.

In the embodiment shown in FIGS. 6 and 7, upon for example vehicular collision or abrupt braking, a downward load acts on the front portion of a seat cushion 1 so as to deform the beam or submarine pipe 4. Then, the leg members 9b on the submarine pipe 4 as the deformation suppressive means 9 contact at their lower portions with a floor 8 to suppress the deformation of the submarine pipe 4, which similarly means that rigidity of the seat cushion 1 can be enhanced with no reinforcement such as increase in diameter and/or thickness of the beam or submarine pipe 4 and/or the seat cushion frame 3, making the beam and/or the frame double-walled and/or use of high-strength material for the beam and/or the frame. When a child seat 5 is set on the seat cushion 1, displacement of the child seat 5 can be suppressed upon generation of shock.

Unlike the bent 9a (see FIGS. 3 and 4) which has restriction in position relationship with the occupant for prevention of the submarine phenomenon as well as restriction in shape itself for workability, the scaffold-shaped leg members 9b on the lower portion of the submarine pipe 4 as shown in FIGS. 6 and 7 have greater degree of freedom in positioning and shape itself. Ordinal installability of the seat to the vehicle is not barred since no change is made on the floor 8.

The leg members 9b may be partially welded to the seat cushion frame 3 as shown in FIG. 8 so as to enhance their strength.

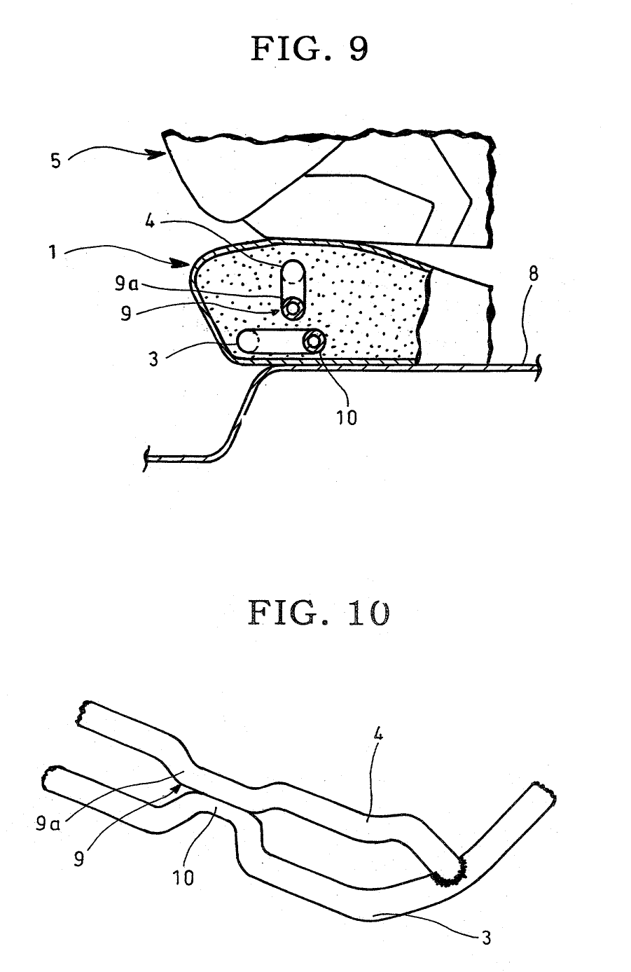

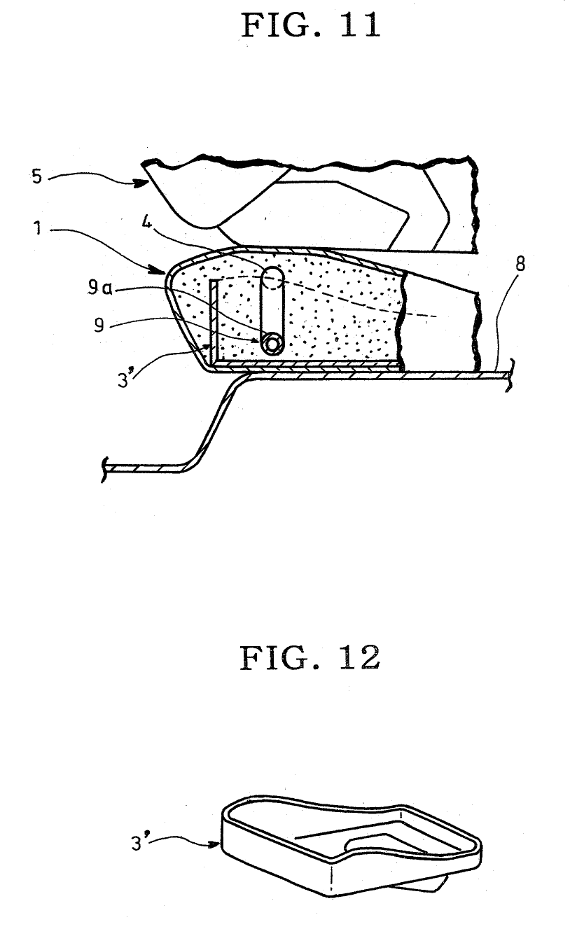

In the above embodiment, the floor 8 on which the seat cushion 1 is installed serves as the other region against the deformation of the submarine pipe 4. Alternatively, for example as shown in FIGS. 9 and 10, a beam or submarine pipe 4 may be formed with a bent 9a (or leg members 9b as shown in FIGS. 6 and 7) as the deformation suppressive means 9 and a further bent 10 is correspondingly formed on a seat cushion frame 3 as the other region against the deformation of the submarine pipe 4. This can reduce an amount of bending of the beam or submarine pipe 4 (or height of the leg members 9b as shown in FIGS. 6 and 7) to suppress increase in processing cost and facilitate assurance of the rigidity whereas the seat cushion frame 3 is made inherently from material which is stronger than that of the floor 8 and which is more advantageous against the deformation and needs no specific countermeasure for prevention of deformation. As shown in FIGS. 11 and 12, a pan type seat cushion frame 3′ may be alternatively employed as the other region against the deformation of the submarine pipe 4.

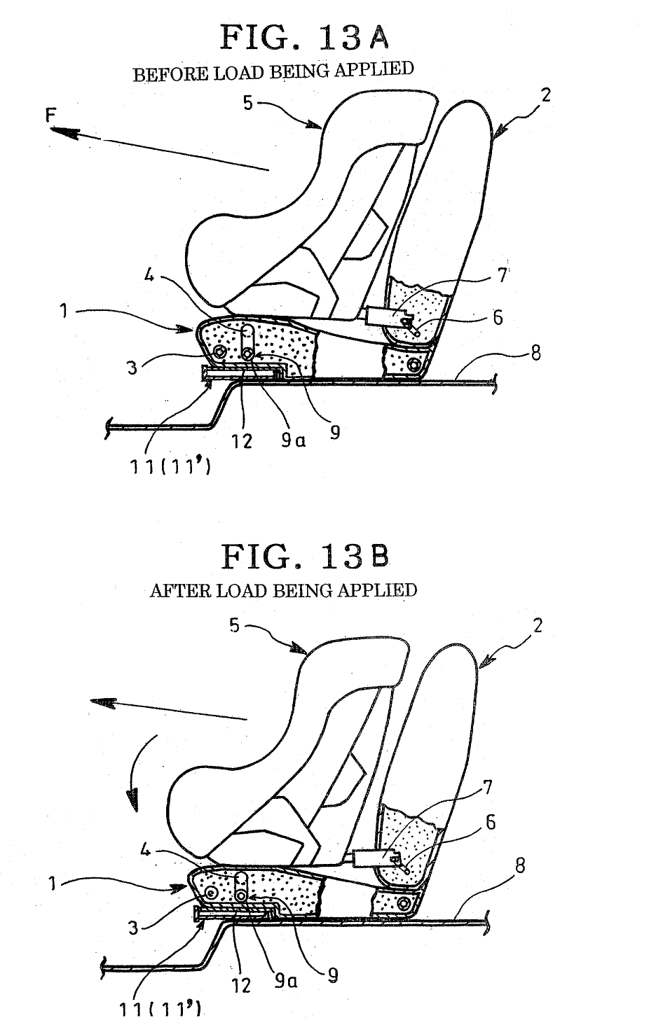

Furthermore, as shown in FIGS. 13A and 13B, an upper plate 12 of a drawer type storage 11 (or of a cup holder 11′) arranged under the seat cushion may be employed as the other region against the deformation of the beam or submarine pipe 4. This can reduce, in providing a downward bent 9a (or leg members 9b as shown in FIGS. 6 and 7) as deformation suppressive means 9, an amount of bending of the beam or submarine pipe 4 to suppress the processing or working cost and facilitate assurance of the rigidity whereas the upper plate 12 of the storage 11 (or of the cup holder 11′) under the seat cushion 1 is usually made of thick plate metal or from highly rigid resin and needs no specific countermeasure for prevention of deformation nor change in shape.

As mentioned above, the other region may be provided for example by the floor 8, the bent 10 of the seat cushion frame 3, the pan type seat cushion frame 3′ or the upper plate 12 of the storage 11 (or of the cup holder 11′). Any other portion or part may be also employed as the other region provided that it is positioned blow the beam or submarine pipe 4.

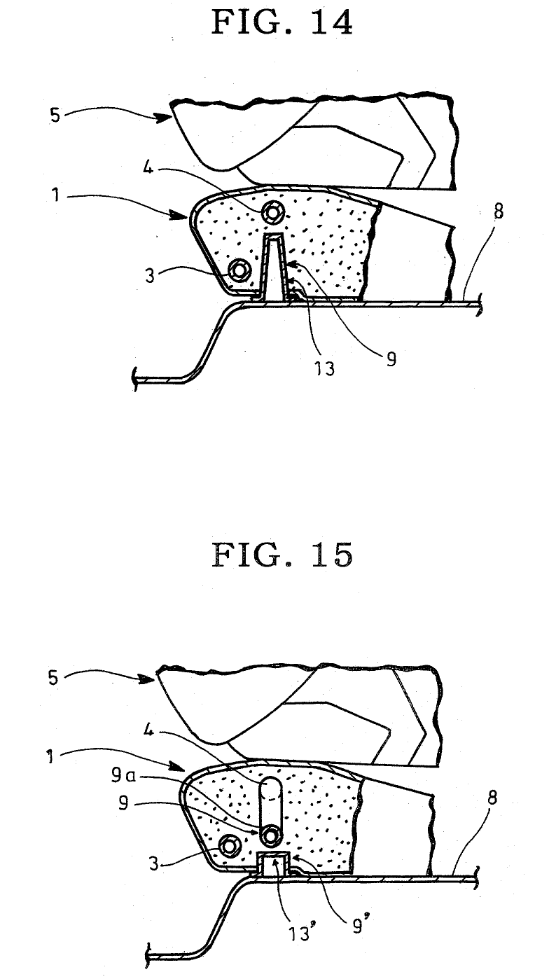

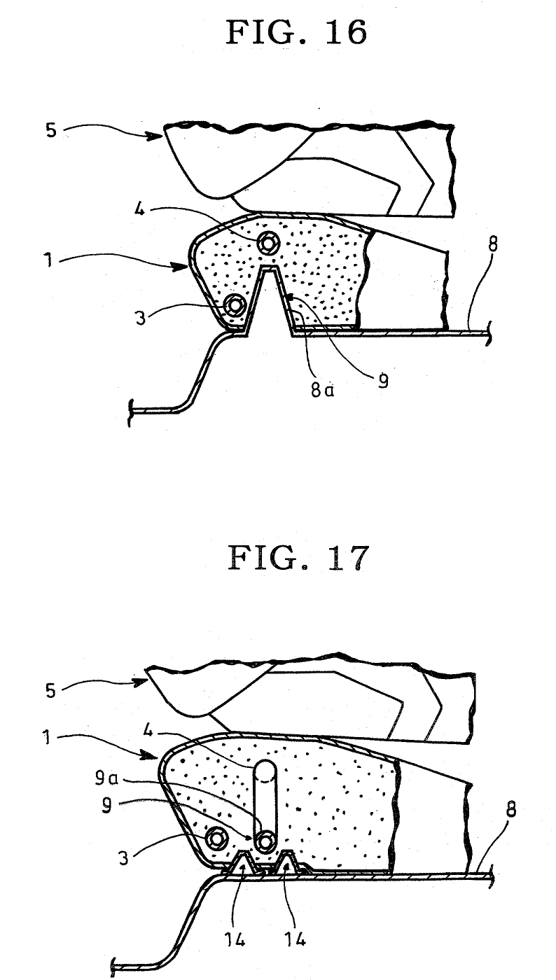

Moreover, as shown in FIG. 14, the floor 8 on which the seat cushion 1 is installed may be employed as the other region and a protrusion or bracket 13 is formed on the floor 8 as the deformation suppressive means 9 against the deformation of the beam or submarine pipe 4. Furthermore, as shown in FIG. 15, the floor 8 on which the seat cushion 1 is installed may have a low protrusion or bracket 13′ as the deformation suppressive means 91 and the submarine pipe 4 may also have a bent 9a (or leg members 9b as shown in FIGS. 6 and 7) which suppresses the deformation of the pipe as the deformation suppressive means 9. In this case, the deformation suppressive means 9′ and 9 on the floor 8 and the beam or submarine pipe 4 may have reduced degree of projections, which is advantageous in workability and in assurance of rigidity. Moreover, as shown in FIG. 16, the floor 8 on which the seat cushion 1 is installed may be integrally formed with a projection or bead 8a as the deformation suppressive means 9 against the deformation of the beam or submarine pipe 4. Further, the bead 8a may be combined with the bent 9a or leg members 9b on the submarine pipe 4; in this case, the bracket 13 or 13′ as shown in FIGS. 14 or 15 is not needed, resulting in decrease of number of parts needed.

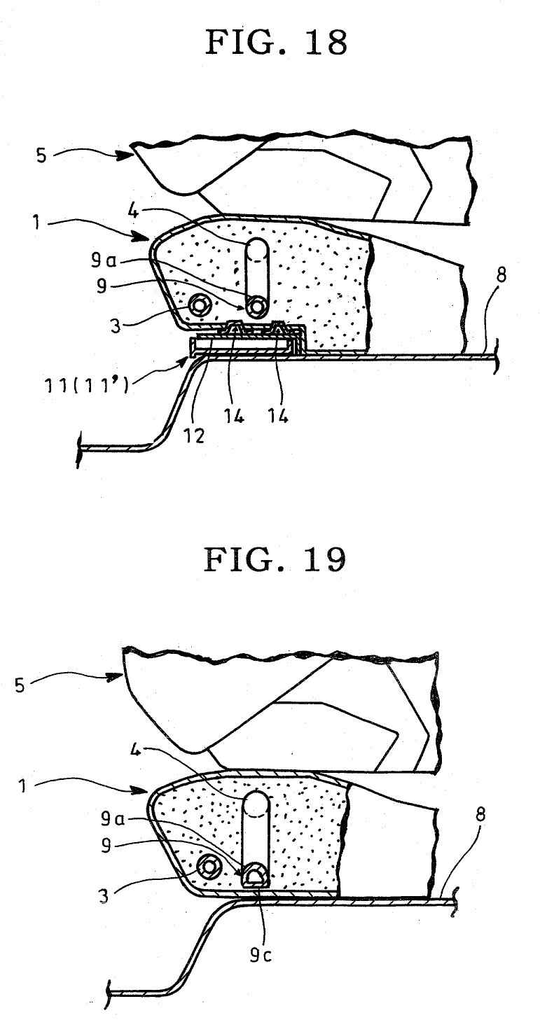

Furthermore, as shown in FIG. 17, an upper surface of the floor 8 as the other region may have protruding guides 14 to guide a downward movement of the bent 9a on the beam or submarine pipe 4, which enables the bent 9a on the beam or submarine pipe 4 to be guided into assured contact with the floor 8 as the other region. As shown in FIG. 18, a similar advantage may be obtained by arranging protruding guides 14 on an upper surface of the upper plate 12 of the storage 11 (or of the cup holder 11′) as the other region. Furthermore, in order to obtain a similar advantage, the guides 14 may be alternatively arranged on an upper surface of the pan type seat cushion frame 3′ (see FIGS. 11 and 12), of the projection or bracket 13 or 13′ on the floor 8 (see FIGS. 14 and 15) or of the bead 8a (see FIG. 16) as the other region.

Further, as shown in FIG. 19, a bent 9a on a beam or submarine pipe 4 may have a flat bottom surface 9c, which allows the bent 9a to be assuredly received by a part or portion, as the other region, below the submarine pipe 4 such as the floor 8, preventing the beam or submarine pipe 4 from being collapsingly deformed.

It is to be understood that the present invention is not limited to the above-mentioned embodiments and modifications and that various changes may be made without departing from the spirit of the invention.

As is clear from the foregoing, according to a seat structure for a vehicle of the invention, rigidity of a seat cushion can be enhanced and increase in weight and cost can be suppressed with no reinforcement such as increase in diameter and/or thickness of the beam and/or the seat cushion frame, making the beam and/or the frame double-walled and/or use of high-strength material for the beam and/or the frame. When a child seat is set on the seat cushion, displacement of the child seat can be suppressed upon generation of shock to thereby attain stabilization of the seat with the child seat being set.

What is claimed is:

1. A seat structure for a vehicle comprising a seat cushion, a seat cushion frame accommodated in the seat cushion, a beam in a front portion of the seat cushion and extending transversely of the vehicle and deformation suppressive means on at least one of the beam and an other region for suppressing deformation of the beam through contact with the other region when a downward load acts on the front portion of the seat cushion.

2. The seat structure according to claim 1 wherein the deformation suppressive means is provided by a downward bent on the beam.

3. The seat structure according to claim 1 wherein the deformation suppressive means is provided by leg members attached to a lower portion of the beam.

4. The seat structure according to claim 1 wherein the other region is provided by a floor on which the seat cushion is installed, the deformation suppressive means being provided by a protrusion on the floor.

5. The seat structure according to claim 2 wherein the other region is provided by a floor on which the seat cushion is installed, the deformation suppressive means being provided by a protrusion on the floor.

6. The seat structure according to claim 3 wherein the other region is provided by a floor on which the seat cushion is installed, the deformation suppressive means being provided by a protrusion on the floor.
